(19) United States
(12) Patent Application Publication
(10) Pub. No.: US 2012/0103158 A1
(43) Pub. Date: May 3, 2012

(54) WEB CUTTING DEVICE

(75) Inventors: Naofumi TAMURA, Tsukuba-shi (JP); Genki SUZUKI, Tsukuba-shi (JP)

(73) Assignee: KOMORI CORPORATION, Tokyo (JP)

(21) Appl. No.: 13/286,270

(22) Filed: Nov. 1, 2011

(30) Foreign Application Priority Data
Nov. 2, 2010 (JP) 2010-245969

(51) Int. Cl. B26D 5/02; B26D 5/04

(52) U.S. Cl. 83/564

(57) ABSTRACT

A web cutting device, which achieves cost reduction by a simplified structure, ensures operational stability, and enhances the reliability of the device, is provided. The web cutting device is equipped with a knife for cutting a web, and comprises: a cutting blade support member supporting the knife and supported to be pivotable between a standby position and a cutting position; a return spring for urging the cutting blade support member toward the standby position; a stopper pin and an engaging groove for stopping the cutting blade support member at least at the standby position; a cutting blade bearing member provided with a slit for receiving the knife, and a knock bolt for pivoting the cutting blade support member to the cutting position; and drive means, composed of an L-shaped lever and an air cylinder, for moving the cutting blade bearing member toward and away from the cutting blade support member.

### TECHNICAL FIELD

The present invention relates to a web cutting device of a rotary offset printing press for applying printing to a web.

### BACKGROUND ART

With a rotary offset printing press for applying printing to a web, when breakage of the web (paper breakage) occurs, the web wraps around the circumferential surface of a blanket cylinder because of adhesion of ink. This has led to an accident such as damage to a cylinder bearing or a cylinder shaft of the blanket cylinder.

As disclosed in Patent Document 1, etc., therefore, a web cutting device for cutting the web at the same time that the breakage of the web is detected is provided on the travel path of the web (for example, between respective printing units and between a final printing unit and a dryer). By so doing, the length of the web wrapping around the blanket cylinder is minimized, whereby an accident such as damage to the cylinder bearing or cylinder shaft of the blanket cylinder has been avoided.

In the web cutting device of Patent Document 1, as shown in FIGS. 7 and 8, an elongated frame 100 is installed to cross the travel direction of a web W, and a passage space 101 for passage of the web W is provided within the frame 100. This passage space 101 accommodates a blade 102, an elongated pedestal 103 facing the blade 102, and an approach mechanism 104 for bringing the blade 102 close to the pedestal 103 within the passage space 101 in order to cut the web W.

The approach mechanism 104 includes link rod assemblies 105a and 105b arranged symmetrically with respect to a plane P parallel to the travel direction of the web W. Each link rod assembly 105a or 105b has a first link rod 107 connected to the frame 100 via a first support shaft 106, and a second L-shaped link rod 110 joined to the first link rod 107 by a second support shaft 109 at a control joint (connecting portion) 108. The blade 102 and at least one press 111 extending parallel to the blade 102 are joined to the second link rod 110 in a coupling arrangement via a slot 112 and a third support shaft 113 and a support shaft 114. At least one operating jack 115 is present which has ends joined to the control joints 108 (second support shafts 109) of the link rod assemblies 105a and 105b.

According to the above-described configuration, when the web W is to be cut, the first link rod 107 and the second link rod 110 shift from a folded (closed) state to an extended (opened) state as the operating jack 115 extends. As a result, the press 111 and the blade 102 descend within the passage space 101 to approach the pedestal 103. At the very time when the first link rod 107 and the second link rod 110 have maximally extended (when the spacing between the press 111 and the pedestal 103 has fully narrowed), the blade 102 jumps downwardly (outwardly) of the press 111 to cut the web W (see the standby state of the blade in FIG. 7→the cutting state of the blade in FIG. 8).

In the manner mentioned above, with the web cutting device of Patent Document 1, at the time of breakage of the web W, the web W is instantaneously cut to minimize the length of the web W wrapping about the blanket cylinder, thereby preventing the occurrence of an accident such as damage to the cylinder bearing or cylinder shaft of the blanket cylinder, and also preventing an operator's hand from being injured by the blade 102 jumping out.

### CITATION LIST

[Patent Literature]
[Patent Document 1] European Patent 0686505

### SUMMARY OF INVENTION

### Technical Problem

With the web cutting device of Patent Document 1, however, the approach mechanism 104 comprises the link rod assemblies 105a and 105b each including the first link rod 107, the second link rod 110, the first to third support shafts 106, 109, 113, the support shaft 114, and the slot 112. Since the structure is thus complicated and the number of the components is great, the problem has arisen that a cost increase is entailed.

Furthermore, holdback may occur at the junction of the first and second link rods 107 and 110 connected by the second support shaft 109, the junction of the second link rod 110 and the press 111 connected by the support shaft 114, or the junction of the second link rod 110 and the blade 102 connected by the third support shaft 113. Hence, the reliability of the web cutting device has been low.

It is an object of the present invention, therefore, to provide a web cutting device which achieves cost reduction by a simplified structure, ensures operational stability, and enhances the reliability of the device.

### Solution to Problem

A web cutting device according to the present invention, intended to solve the above-mentioned problems, is a web cutting device equipped with a cutting blade for cutting a web, comprising:

a cutting blade support member supporting the cutting blade and supported to be pivotable between a standby position and a cutting position;

an elastic member for urging the cutting blade support member toward the standby position;

a position restricting member for stopping the cutting blade support member at least at the standby position;

a cutting blade bearing member provided with a blade receiving portion for receiving the cutting blade, and an operating portion for pivoting the cutting blade support member to the cutting position; and

drive means for moving the cutting blade bearing member toward and away from the cutting blade support member.

The cutting blade support member may comprise: a body portion having the cutting blade of a saw blade shape secured thereto; support shaft portions annexed to opposite end parts of the body portion and pivotably supported by side frames via bearings; lever portions which are provided on the support shaft portions to extend in a direction orthogonal to an axis of the body portion, and against one end part of each of which the operating portion can be pressed; engaging grooves which are provided in the one end part of each of the lever portions, and with which stopper pins being the position restricting members provided protrusively at the side frames can engage at the standby position and the cutting position; and spring hooks which are provided in another end part of each of the lever portions, and which hold return springs being the elastic members in cooperation with the side frames.

The cutting blade support member may be entirely shielded by a cover, and an opening allowing cutting edges of the cutting blade to enter and exit may be formed in a lower surface part of the cover.

The cutting blade bearing member may be a casing-shaped cover opening downward, and a slit as the blade receiving portion may be formed in a top surface part of the cover.

The cutting blade support member may support the cutting blade of a saw blade shape, the cutting blade bearing member may be a casing-shaped cover opening downward, and many engaging knife holes as the blade receiving portion may be arranged in a row in a top surface part of the cover in correspondence with sawteeth of the cutting blade.

At least two of the drive means may be provided in a width direction of the web, and each of the drive means may be composed of an L-shaped lever for connecting a stay, which is provided to span side frames, to the cutting blade bearing member located above the stay, and an air cylinder interposed between an intermediate part of the L-shaped lever and the stay.

The L-shaped levers may be provided frontward and rearward as a pair, upper end parts of the L-shaped levers may be joined by separate pins to side surface parts of a casing-shaped cover opening downward as the cutting blade bearing member, while lower end parts of the L-shaped levers may be joined by the same support shaft to the stays provided frontward and rearward as a pair, and a leading end of a piston rod of the air cylinder may be joined by the same support shaft to the intermediate parts of the L-shaped levers provided frontward and rearward as a pair, while a base end of a head of the air cylinder may be joined by the same support shaft to the stays provided frontward and rearward as a pair.

### Advantageous Effects of Invention

According to the above-described web cutting device concerned with the present invention, the cutting blade bearing member is approached and moved to the cutting blade support member and, at a later stage of this movement, the cutting blade support member is pivoted by the operating portion. Because of such a simple structure, an injury to the operator is prevented, and the web can be reliably cut. The simplification of the structure results in cost reduction. Moreover, the stability of operation is ensured, and the reliability of the device is enhanced.

### BRIEF DESCRIPTION OF DRAWINGS

FIG. 1 is a sectional front view of a web cutting device showing Embodiment 1 of the present invention.

FIG. 2 is a sectional bottom view of the web cutting device.

FIG. 3 is a sectional plan view of the web cutting device.

FIG. 4-A is a sectional view taken along line A-A in FIG. 1.

FIG. 4-B is a sectional view taken along line B-B in FIG. 1.

FIG. 4-C is a sectional view taken along line C-C in FIG. 1.

FIGS. 5(a) to 5(c) are operating state views of the web cutting device, in which FIG. 5(a) shows the position of a knife when a clearance is 10 mm, FIG. 5(b) shows the position of the knife when it contacts the web, and FIG. 5(c) shows the position of the knife when cutting the web, while pressing it down, up to a stopper.

FIG. 6 is a sectional plan view of a web cutting device showing Embodiment 2 of the present invention.

FIG. 7 is a sectional front view of a conventional web cutting device during standby of a blade.

FIG. 8 is a sectional front view of the conventional web cutting device when the blade is cutting a web.

### DESCRIPTION OF EMBODIMENTS

Hereinafter, a web cutting device according to the present invention will be described in detail by embodiments with reference to the accompanying drawings.

### Embodiment 1

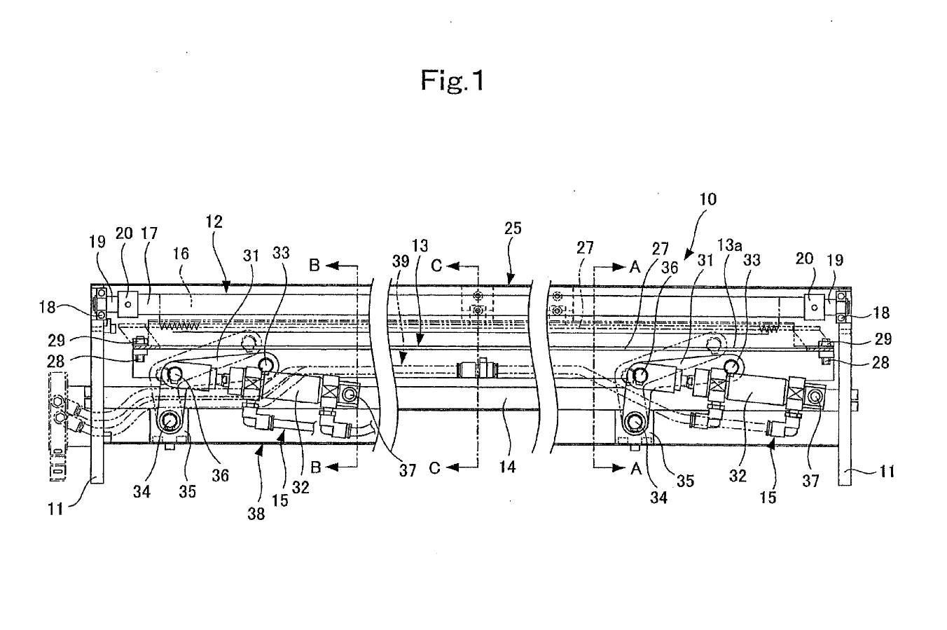

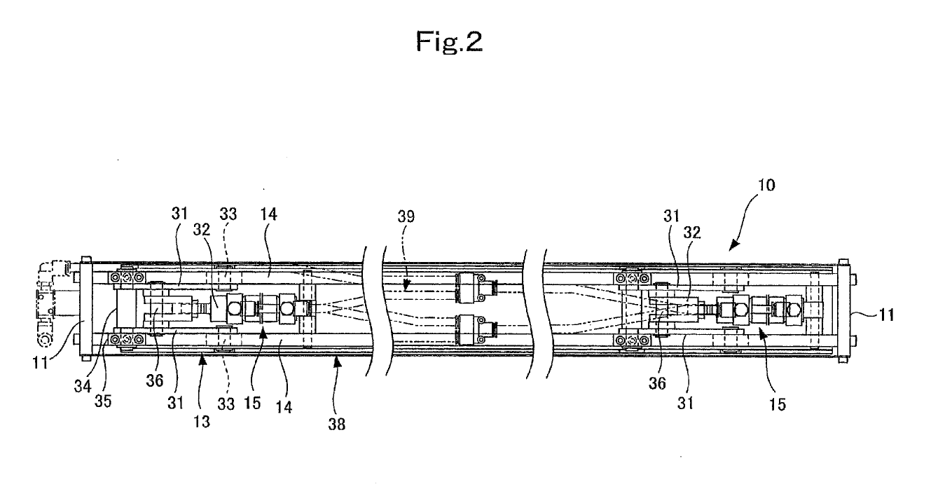

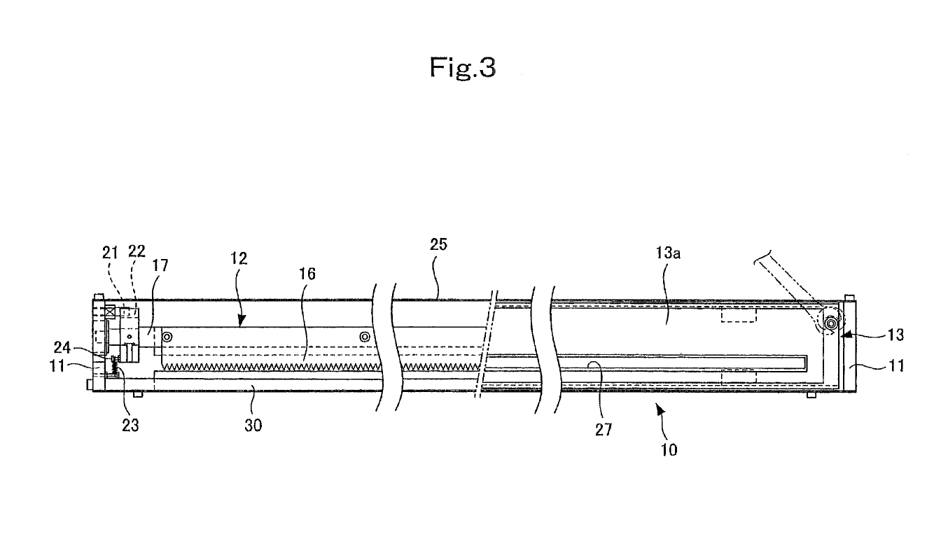

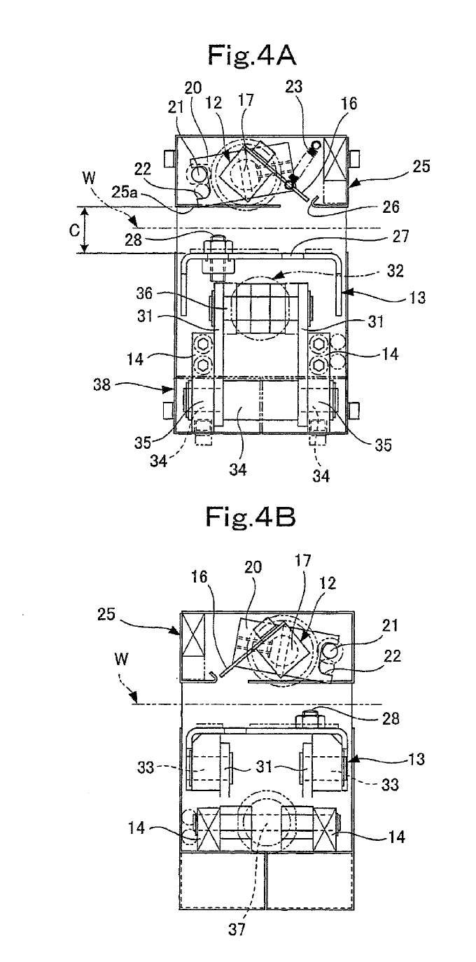

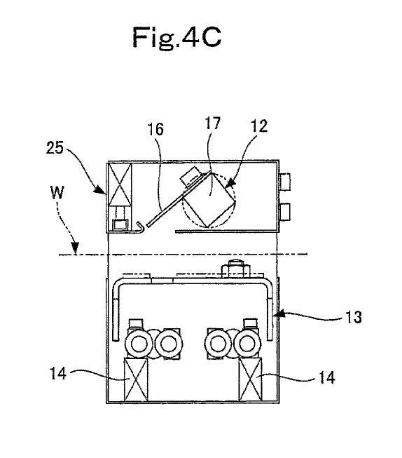

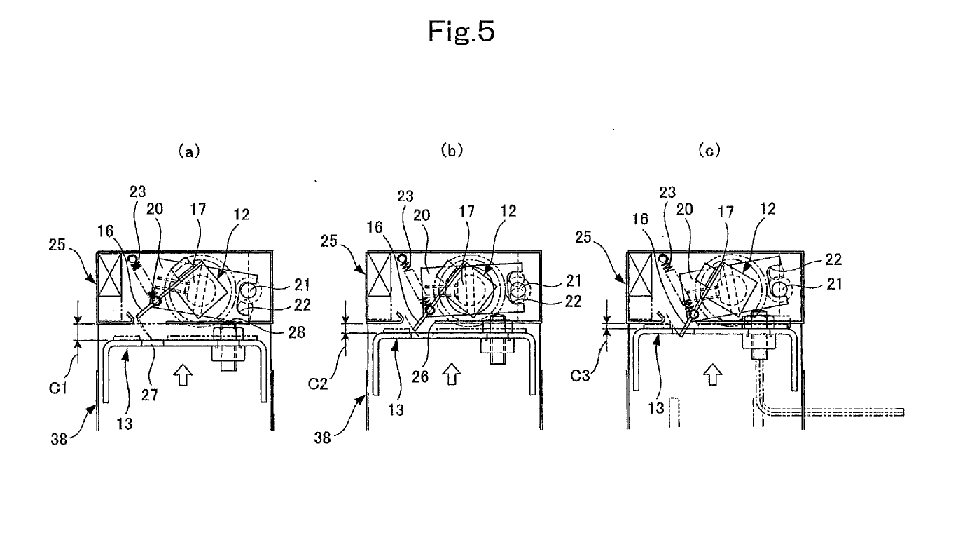

FIG. 1 is a sectional front view of a web cutting device showing Embodiment 1 of the present invention. FIG. 2 is a sectional bottom view of the web cutting device. FIG. 3 is a sectional plan view of the web cutting device. FIG. 4-A is a sectional view taken along line A-A in FIG. 1. FIG. 4-B is a sectional view taken along line B-B in FIG. 1. FIG. 4-C is a sectional view taken along line C-C in FIG. 1. FIGS. 5(a) to 5(c) are operating state views of the web cutting device, in which FIG. 5(a) shows the position of a knife at the initial stage of pressing by a knock bolt, FIG. 5(b) shows the position of the knife in the course of pressing by the knock bolt, and FIG. 5(c) shows the position of the knife when cutting a web while the knock bolt is pressing the knife.

As shown in the drawings, a web cutting device 10 of a rotary offset printing press has a cutting blade support member 12 pivotably installed between right and left side frames 11. A cutting blade bearing member 13 is located below the cutting blade support member 12, and is supported by front and rear stays 14 as a pair, which are installed between the right and left side frames 11, so as to be rendered ascendable and descendable by right and left drive means 15 as a pair, in other words, so as to be movable by these drive means 15 toward and away from the cutting blade support member 12.

The cutting blade support member 12 has a body portion (holder) 17 in which a saw blade-like knife (cutting blade) 16 is secured, with its cutting edges protruding, to one side of its prismatic body; support shaft portions 19 annexed to opposite end faces of the body portion 17 and pivotably supported by the side frames 11 via bearings 18; and prismatic lever portions 20 extending on the support shaft portions 19 in a direction orthogonal to the axes thereof and having lower surface parts on one end side against which knock bolts to be described later can be pressed.

In an end face part on one end side of each lever portion 20, there is formed an engaging groove 22 with which a stopper pin (position restricting member) 21 provided protrusively at the side frame 11 can engage at the standby position (see FIG. 5(a)) and the cutting (force-cutting) position (see FIG. 5(c)) of the knife 16. In a side surface part on the other end side of each lever portion 20, there is provided a spring hook 24 for holding a return spring (elastic member) 23 which urges the cutting blade support member 12 (knife 16) toward the standby position in cooperation with the side frame 11.

A cover 25 entirely shields the cutting blade support member 12, and an opening 26 allowing the cutting edges of the knife 16 to enter and exit is formed in a lower surface part 25a of the cover 25. A stay 30 for reinforcing the cover is installed to span the right and left side frames 11.

The cutting blade bearing member 13 is a casing-shaped cover with an open lower surface. A slit (blade receiving portion) 27 corresponding to the opening 26 is formed in a top surface part 13a of the cutting blade bearing member 13. The aforementioned knock bolt (operating portion) 28, which can be pressed against the lower surface part on the one end side of the lever portion 20, is screwed to the top surface part 13a of the cutting blade bearing member 13 via a nut 29.

The drive means 15 is provided in two sets (optionally, three sets or more) in the width direction of the web W, each of the sets being composed of front and rear L-shaped levers 31 as a pair which connect the front and rear stays 14 as a pair spanning the side frames 11 to the cutting blade bearing member 13 positioned above the stays 14; and an air cylinder 32 interposed between intermediate parts of the front and rear L-shaped levers 31 as a pair and the front and rear stays 14 as a pair.

The front and rear L-shaped levers 31 as a pair have upper end parts joined to side surface parts of the cutting blade bearing member 13 by separate pins 33, and have lower end parts joined to support plate portions 35 of the front and rear stays 14 as a pair by the same support shaft 34. The leading end of a piston rod of the air cylinder 32 is joined to intermediate parts of the front and rear L-shaped levers 31 as a pair by the same support shaft 36, whereas the base end of a head of the air cylinder 32 is joined to the front and rear stays 14 as a pair by the same support shaft 37.

A cover 38 shields the side surfaces and lower surface of the cutting blade bearing member 13 and the drive means 15. Air piping 39 allows air to be supplied from an air supply source (not shown) to the air cylinder 32 and to be discharged from the air cylinder 32.

Because of the above-described features, the air cylinder 32 in the drive means 15 of the web cutting device 10 is contracted during ordinary printing to bring the L-shaped levers 31 into a state indicated by solid lines in FIG. 1. That is, the cutting blade bearing member 13 is separated from the cutting blade support member 12.

As a result, a clearance C adequate as a passage space for passage of the web W is ensured, as shown in FIGS. 4A to 4C, between the cutting blade support member 12 (its cover 25) and the cutting blade bearing member 13 (its cover 38), so that the web W can travel therethrough smoothly.

On this occasion, the cutting blade support member 12 (lever portion 20) is restricted to the standby position by the return spring 23, the stopper pin 21, and the engaging groove 22, as shown in FIG. 4A.

When the web cutting device 10 cuts the web W in response to the breakage of the web W, the air cylinder 32 in the drive means 15 is extended to pivot the L-shaped levers 31 counterclockwise about the support shaft 34 so that the L-shaped levers 31 are brought from the state indicated by the solid lines into a state indicated by chain lines in FIG. 1.

By the above-mentioned motion, the cutting blade bearing member 13 obliquely ascends (is lifted) as in a so-called parallel link to approach the cutting blade support member 12, exhibiting behaviors as shown in FIGS. 5(a) to 5(c).

That is, as the cutting blade bearing member 13 ascends, the aforementioned clearance C which is the passage space for the passage of the web W narrows over time. In the end, the knock bolt 28 is pressed against the cutting blade support member 12 (lever portion 20). The clearance C changes from a clearance C1 (C1=10 mm, for example) which defines the knife position at the initial stage of pressing by the knock bolt, to a clearance C2 which defines the knife position in the course of pressing by the knock bolt, and to a clearance C3 which defines the knife position when force-cutting upon pressing by the knock bolt.

These changes from the clearances C1 to C2 to C3 are dependent on the protruding height of the knock bolt 28 determined by the adjustment of the degree of screwing-in of the knock bolt 28. With these clearances C1, C2 and C3, an operator's hand can be prevented from being injured by the knife 16 jumping out from inside the cover 25 for the cutting blade support member 12.

The present embodiment features a simple configuration in which the cutting blade bearing member 13 is approached and moved to the cutting blade support member 12 and, at a later stage of this movement, the cutting blade support member 12 is pivoted by the knock bolt 28. Because of such a simple configuration, an injury to the operator is prevented, and the web W is reliably cut, whereby the length of the web W wrapping about the blanket cylinder can be minimized.

Consequently, at the time of breakage of the web W, an accident, such as damage to the cylinder bearing or the cylinder shaft of the blanket cylinder, can be avoided. Moreover, the simplification of the structure of the web cutting device 10 results in cost reduction, and ensures the stability of operation, leading to enhanced reliability.

### Embodiment 2

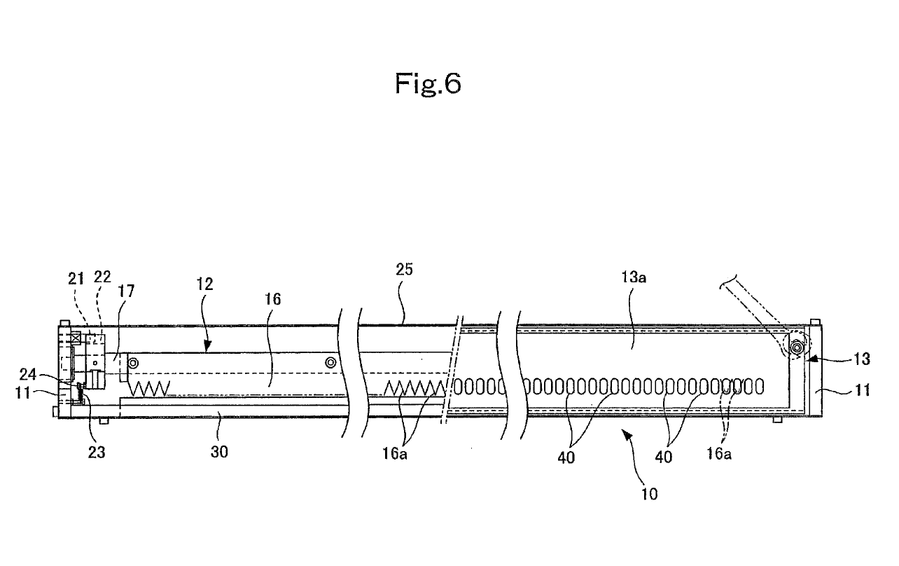

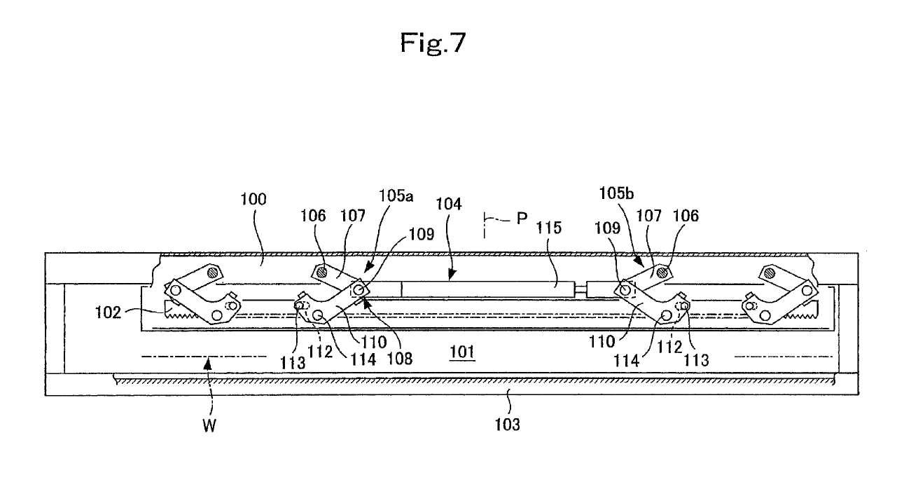

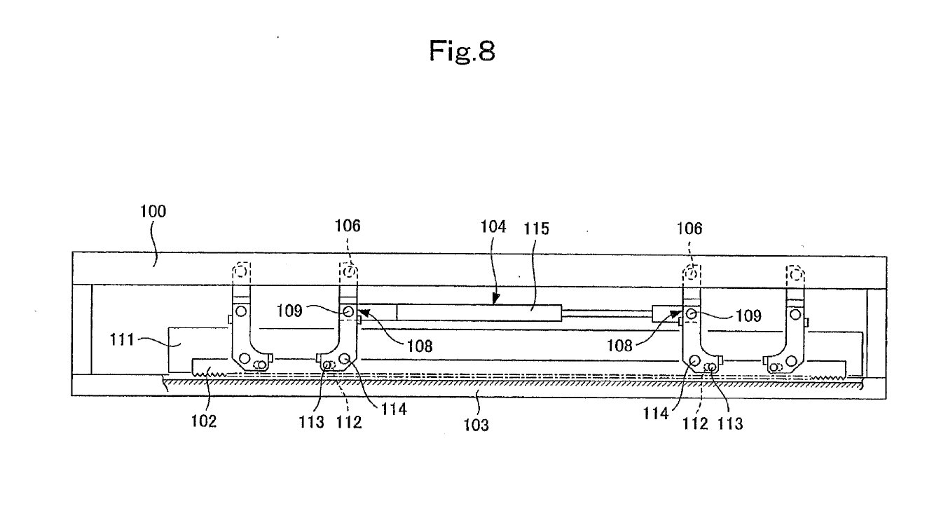

FIG. 6 is a sectional plan view of a web cutting device showing Embodiment 2 of the present invention.

This is an embodiment in which instead of the slit (blade receiving portion) 27 formed in the top surface part 13a of the cutting blade bearing member 13 in Embodiment 1, many engaging knife holes (blade receiving portion) 40 are arranged in a row in correspondence with sawteeth 16a of the saw blade-like knife 16. The other features in the present embodiment are the same as those in Embodiment 1. Thus, the same members as those in FIG. 3 will be assigned the same numerals as those in FIG. 3, and duplicate explanations will be omitted.

According to the present embodiment, in addition to the same actions and effects as those in Embodiment 1, the following advantages are obtained: During cutting, the web W is held by the sections between the engaging knife holes 40 (i.e., the top surface part 13a), so that the web W does not sag, and perforations are formed accurately. Since the web W is pulled forward, moreover, the web W is reliably cut at the perforated area.

It goes without saying that the present invention is not limited to the foregoing embodiments, but various changes and modifications, such as changes in the structures of the cutting blade support member 12 and the cutting blade bearing member 13, changes in the shapes of the respective members, a change in the number of the drive means, changes in the actuators, and a change in the structure of the operating portion, may be made without departing from the gist of the present invention.

### REFERENCE SIGNS LIST

10 Web cutting device
11 Side frame
12 Cutting blade support member
13 Cutting blade bearing member (casing-shaped cover)
13a Top surface part
14 Stay
15 Drive means
16 Saw blade-like knife (cutting blade)
17 Body portion (holder)
18 Bearing
19 Support shaft portion
20 Lever portion
21 Stopper pin (position restricting member)
22 Engaging groove
23 Return spring
24 Spring hook
25 Cover
25a Lower surface part
26 Opening
27 Slit (blade receiving portion)
28 Knock bolt
29 Nut
30 Stay
31 L-shaped lever
32 Air cylinder
33 Pin
34 Support shaft
35 Support plate portion
36 Support shaft
37 Support shaft
38 Cover
39 Air piping
40 Engaging knife hole (blade receiving portion)
C Clearance during ordinary printing
C1 Clearance at initial stage of pressing by knock bolt
C2 Clearance in course of pressing by knock bolt
C3 Clearance during force-cutting upon pressing by knock bolt
W Web

1. A web cutting device equipped with a cutting blade for cutting a web, comprising:
a cutting blade support member supporting the cutting blade and supported to be pivotable between a standby position and a cutting position;
an elastic member for urging the cutting blade support member toward the standby position;
a position restricting member for stopping the cutting blade support member at least at the standby position;
a cutting blade bearing member provided with a blade receiving portion for receiving the cutting blade, and an operating portion for pivoting the cutting blade support member to the cutting position; and
drive means for moving the cutting blade bearing member toward and away from the cutting blade support member.

2. The web cutting device according to claim 1, wherein
the cutting blade support member comprises:
a body portion having the cutting blade of a saw blade shape secured thereto;
support shaft portions annexed to opposite end parts of the body portion and pivotably supported by side frames via bearings;
lever portions which are provided on the support shaft portions to extend in a direction orthogonal to an axis of the body portion, and against one end part of each of which the operating portion can be pressed;
engaging grooves which are provided in the one end part of each of the lever portions, and with which stopper pins being the position restricting members provided protrusively at the side frames can engage at the standby position and the cutting position; and
spring hooks which are provided in another end part of each of the lever portions, and which hold return springs being the elastic members in cooperation with the side frames.

3. The web cutting device according to claim 1, wherein
the cutting blade support member is entirely shielded by a cover, and
an opening allowing cutting edges of the cutting blade to enter and exit is formed in a lower surface part of the cover.

4. The web cutting device according to claim 1, wherein
the cutting blade bearing member is a casing-shaped cover opening downward, and
a slit as the blade receiving portion is formed in a top surface part of the cover.

5. The web cutting device according to claim 1, wherein
the cutting blade support member supports the cutting blade of a saw blade shape,
the cutting blade bearing member is a casing-shaped cover opening downward, and
many engaging knife holes as the blade receiving portion are arranged in a row in a top surface part of the cover in correspondence with sawteeth of the cutting blade.

6. The web cutting device according to claim 1, wherein
at least two of the drive means are provided in a width direction of the web, and
each of the drive means is composed of
an L-shaped lever for connecting a stay, which is provided to span side frames, to the cutting blade bearing member located above the stay, and
an air cylinder interposed between an intermediate part of the L-shaped lever and the stay.

7. The web cutting device according to claim 6, wherein
the L-shaped levers are provided frontward and rearward as a pair,
upper end parts of the L-shaped levers are joined by separate pins to side surface parts of a casing-shaped cover opening downward as the cutting blade bearing member, while lower end parts of the L-shaped levers are joined by a same support shaft to the stays provided frontward and rearward as a pair, and
a leading end of a piston rod of the air cylinder is joined by a same support shaft to the intermediate parts of the L-shaped levers provided frontward and rearward as a pair, while a base end of a head of the air cylinder is joined by a same support shaft to the stays provided frontward and rearward as a pair.

8. The web cutting device according to claim 2, wherein
the cutting blade support member is entirely shielded by a cover, and
an opening allowing cutting edges of the cutting blade to enter and exit is formed in a lower surface part of the cover.
